(19) United States
(12) Patent Application Publication
(10) Pub. No.: US 2022/0028299 A1
(43) Pub. Date: Jan. 27, 2022

(54) Educational Puzzle Generation Software

(71) Applicants: Mariano Garcia, III, New Braunfels, TX (US); Kristy Garcia, New Braunfels, TX (US)

(72) Inventors: Mariano Garcia, III, New Braunfels, TX (US); Kristy Garcia, New Braunfels, TX (US)

(21) Appl. No.: 17/106,014

(22) Filed: Nov. 27, 2020

Related U.S. Application Data
(60) Provisional application No. 62/941,555, filed on Nov. 27, 2019.

(51) Int. Cl. G09B 19/06; G06T 7/11; G06F 3/0482

(52) U.S. Cl. CPC G09B 19/06; G06T 7/11; G09B 19/08; G06T 2200/24; G06F 3/0482

(57) ABSTRACT

A system and method for generating a customizable educational puzzle comprises a processor and a memory. The processor is configured to generate a customizable educational puzzle with determined attachment points based upon educational inquiries. The processor is further configured to request and receive puzzle art work, along with complimentary X and Y axis information which is then used to generate the customizable physical educational puzzle.

This application claims the benefit of provisional patent application 62/941,535.

### BACKGROUND OF THE INVENTION

### Background

This invention relates to puzzle generation software more specifically this invention relates to customizable educational puzzle generation software.

Jigsaw puzzles have been a form of entertainment worldwide for centuries. A jigsaw p normally requires the assembly of often oddly shaped interlocking and tessellating pieces. Each piece usually has a small part of a picture on it; when complete, a jigsaw puzzle produces a complete picture.

Puzzles present many benefits for children as they develop. Children usually start out with simple puzzles that fit into corresponding board cutouts. From there they go to more complex puzzles of real world objects that require a higher level concentration.

As the level of complexity of puzzles grows, the more greater the educational benefit.

Puzzles can provide the following benefits to educational childhood development:

a. Physical Skills
Jigsaw puzzle enhances hand eye coordination along with fine motor skills by allowing a child to develop a relationship between what they see and fine movement skills of placement of puzzle pieces into the right spot.
b. Cognitive Skills
Jigsaw puzzles enhances shape recognition, memory solving skills and memory retention.
c. Emotional Skills
Jigsaw puzzles enhances patience.

The present invention provides an educator the ability to automatically create customizable jigsaw puzzles to fit her classroom educational needs which addresses the aforementioned childhood development skills.

### DESCRIPTION OF DRAWINGS

This invention is described by appended claims in relation to description of a preferred embodiment with reference to the following drawings which are described briefly as follows:

FIG. 1 depicts a sample art work puzzle.

FIG. 2 depicts a sample art work puzzle that has been generated for Spanish Verb conjugation.

FIG. 3 depicts an alternative sample art work puzzle.

FIG. 4 depicts a sample art work puzzle that has been generated for English Verb conjugation.

FIG. 5 depicts a block diagram of the user selection process.

FIG. 6 depicts a block diagram of the puzzle mapping and generation process.

### DESCRIPTION OF INVENTION

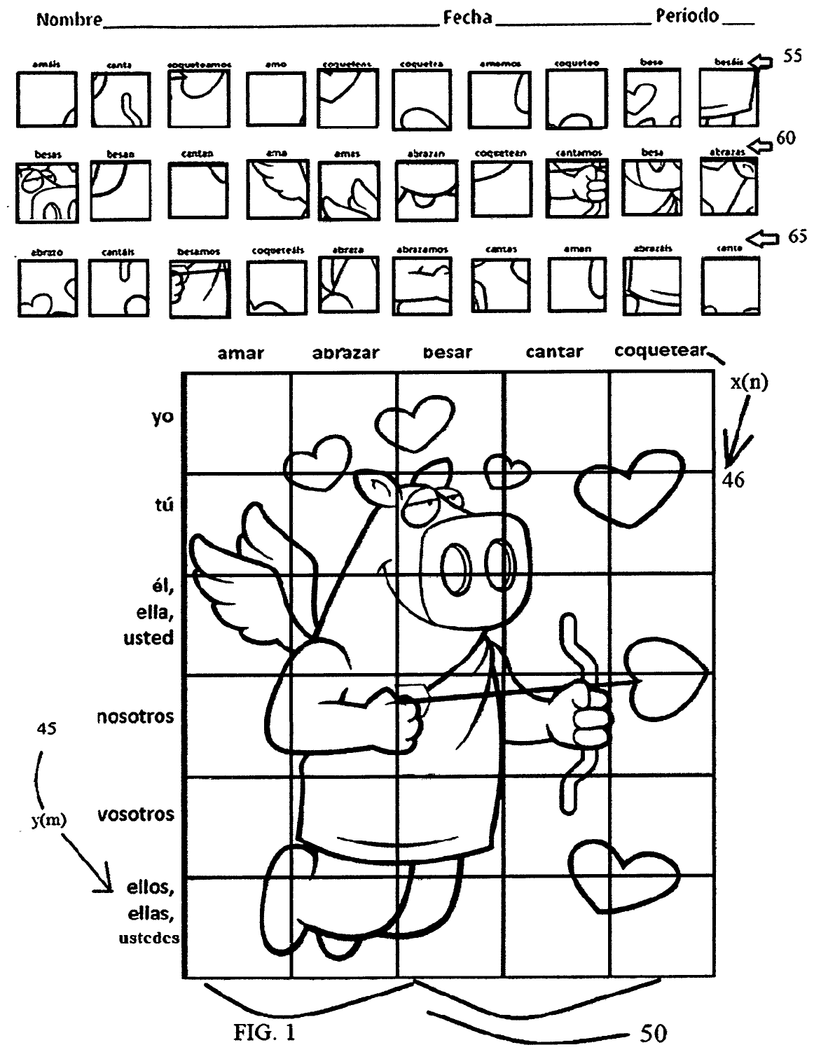

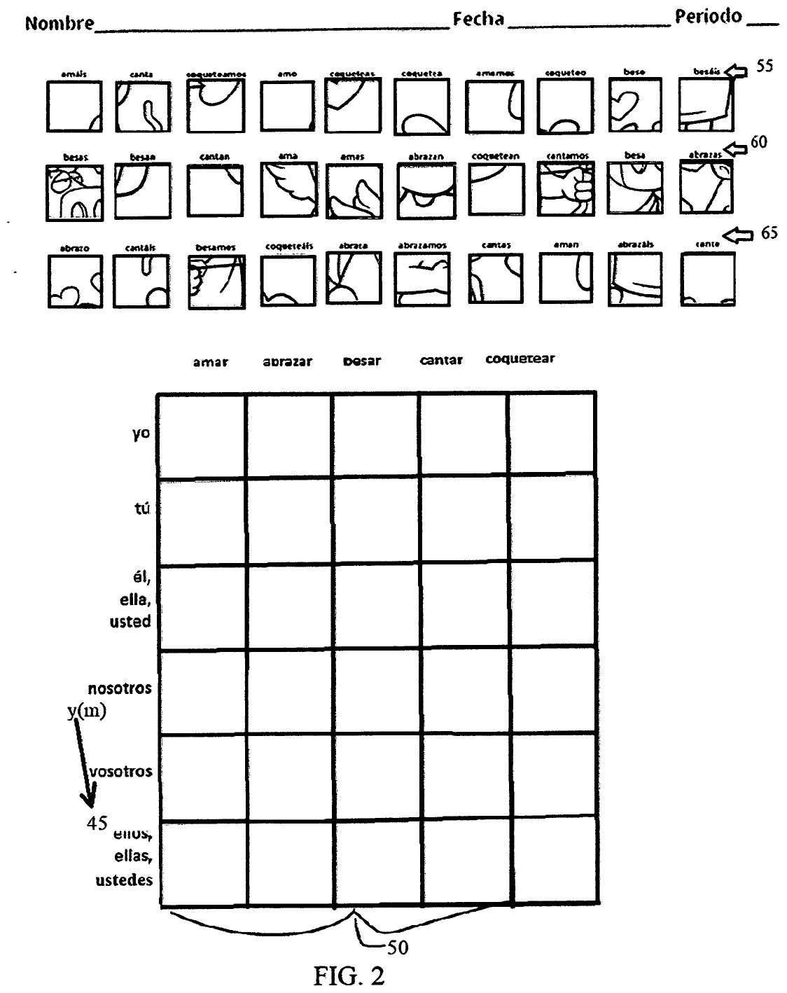

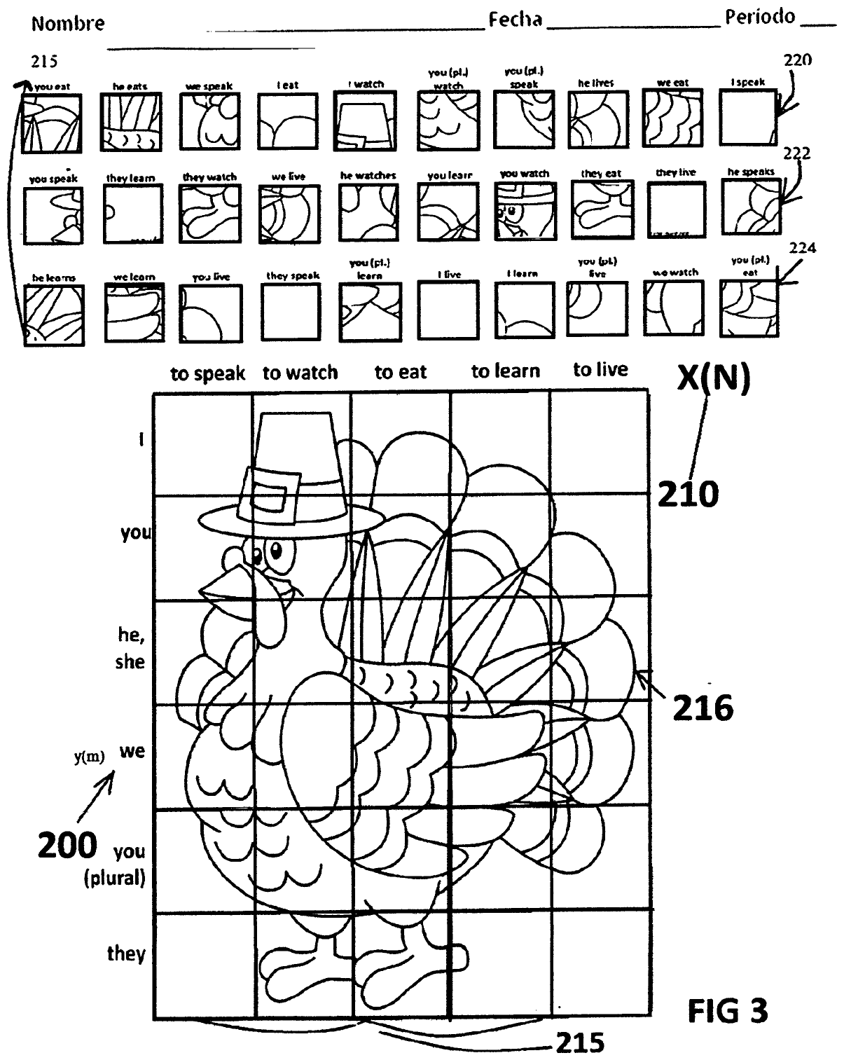

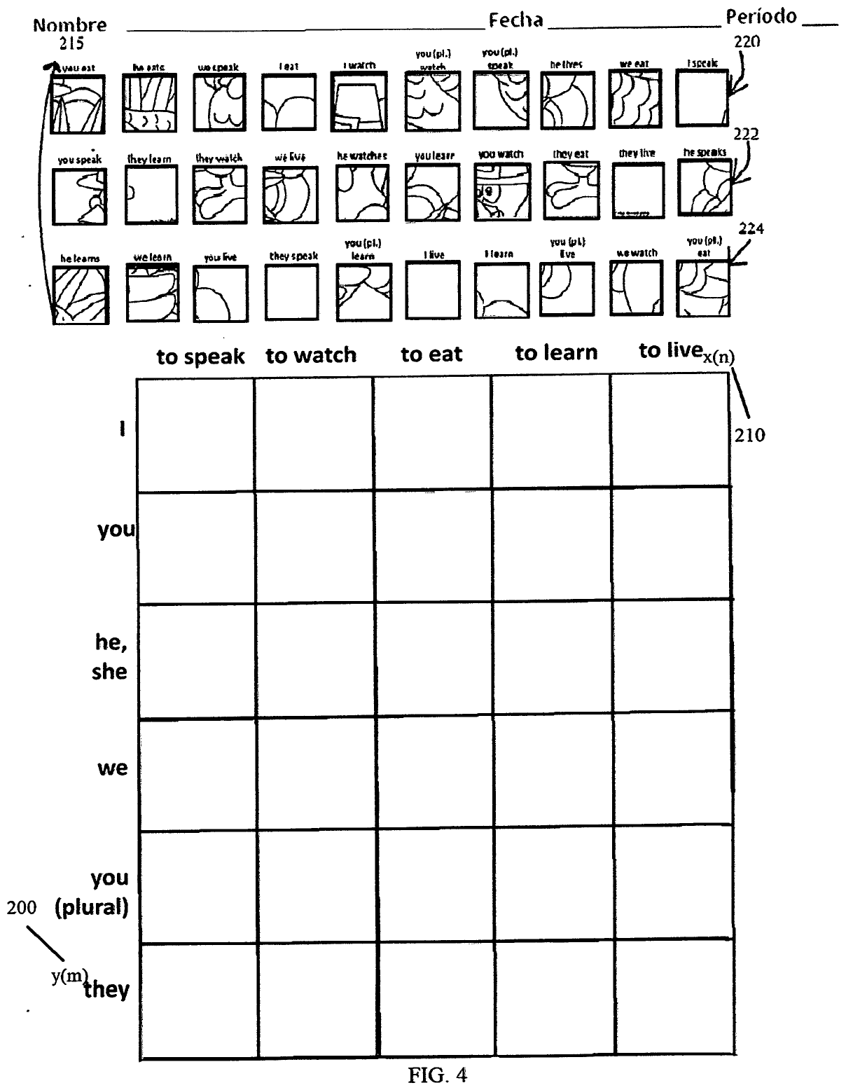

Referring to FIGS. 1 and 2 there is shown a sample customizable puzzle used to conjugate verbs in the Spanish Language. Referring to FIGS. 3 and 4 there is shown a sample customizable puzzle used to conjugate verbs in the English Language. Additionally, FIGS. 1-4 depicts the segmentation and mapping of the image onto a plurality of puzzle pieces.

The present invention comprises a system and method for generating a customizable educational puzzle. The system and method can be implemented preferably implemented in a client/server system or on a stand alone computer system. With this invention, the processor is configured to generate a customizable educational puzzle with determined attachment points.

The system can be implemented wherein the user utilizing the client/server model accesses a server through a local area network (LAN), a wide area network (WAN) or, the internet to access the puzzle mapping and generation process. Alternatively the system can be implemented as a stand-alone software application on an IPAD or a computer. The memory is coupled to the processor and configured to provide the processor with programmed instructions stored in memory.

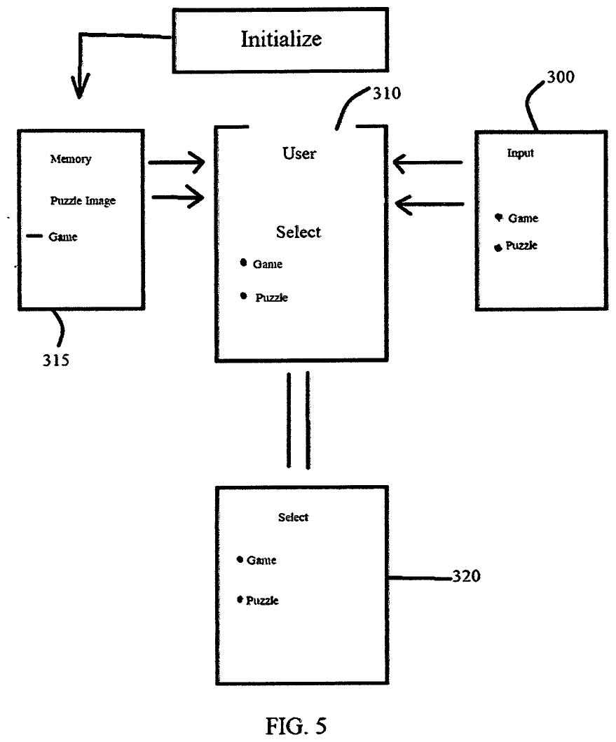

Referring to FIG. 5, the system is programmed to initialize and to store in memory puzzle images and educational games at step 315. At step 310 the processor is further configured with a user interface which allows a user select an educational game and a puzzle image. The user can request and receive puzzle art work, along with complimentary X and Y axis information which is then used to generate the customizable educational puzzle. The processor is further configured to add attachment points and receiving points to the one or more puzzle piece representations. The processor is further configured to provide the one of more puzzle piece representations with attachment points and receiving points based upon the questions of the educational.

As depicted in one embodiment in Figure land 2 the puzzle image is segmented into a plurality of puzzle block images as shown in matrix (50). The matrix comprises 30 pointers designated by line (55), line (60), and line (65). As depicted each block of matrix (50) points to an answer and a puzzle piece of the image (50). As depicted below Y(m) (45) points to an a list of clues and X(n) (46) points to a list of clues. Matrix (50) maps an answer to a puzzle piece which is designated by line (55), line (60), and line (65).

As depicted in one embodiment in FIGS. 3 and 4 the puzzle image is segmented into a plurality of puzzle block images as shown in matrix (215). The matrix comprises 30 pointers designated by line (220), line (222), and line (224). As depicted each block of matrix (215) points to an answer and a puzzle piece of the image (216). As depicted below Y(m) (200) points to an a list of clues and X(n) (210) points to a list of clues. Matrix (215) maps an answer to a puzzle piece which is designated by line (220), line (222), and line (224). The software can be programed to generate game answers based upon a specified game stored in memory instead of having a user input the answers. The software is stored in non-transitory memory with programmed instructions.

In each depicted image in FIG. 1-4, the X axis has five blocks and the Y axis has six blocks. Each empty box (X,Y) represents an answer that the student must determine in order to complete each puzzle piece. As shown above each puzzle piece represents a correct answer that must be determined by the student.

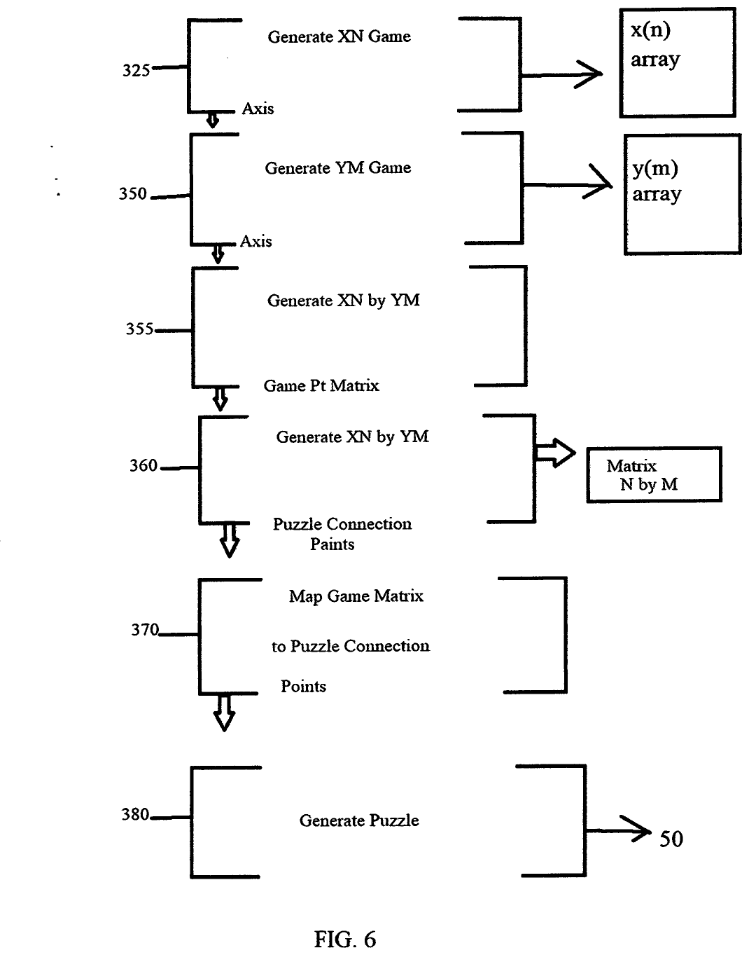

Referring to FIGS. 5 and 6, there is shown a block diagram of the puzzle generation process. The computer is programed with instructions to perform the following steps to support the aforementioned method and documented below:

(a) Select visual artwork used to generate the puzzle; the artwork can be selected from artwork that is currently in memory, customize artwork that is stored in memory, or upload new artwork into memory.

(b) Request X(n) axis information which is the vertical axis wherein n defines the number of vertical educational matrix memory block clues;

(c) Request Y(m) axis information which is the horizontal axis wherein m defines the number of horizontal educational matrix memory block clues;

(d) The puzzle memory matrix is defined by n multiplied by m wherein each X by Y block defines in the matrix memory is associated with an answer; the answer is defined by X(n) applied with Y(m);

(e) Segment the artwork into a plurality of artwork pieces in memory;

(f) For each answer memory block related to a specific piece of the puzzle in the visual artwork in memory;

(g) Physically create the plurality of artwork pieces; and

(h) Physically generate each artwork piece with its related answer.

The puzzle pieces can be generated as plastic, cardboard, wood, paper or another suitable firm piece of material. The puzzle pieces can be manufactured to interlock or to fit side-by-side.

Alternatively, educational puzzle pieces can be generated as digital physical puzzle pieces that can be electronically manipulated on an electronic display using input devices on the computer, iPhone, iPad, or another personal computing device.

What is claimed is:

1. A non-transitory computer readable memory medium comprising instructions, when executed by a computer processor perform a method, the method comprising:
Receiving a user selected puzzle image;
Receiving a user selected game;
Generating an x(n) array of pointer in memory for the user selected game;
Generating a y(m) array of points in memory for the user selected game;
Generating an image matrix of n by m of pointers;
Segmenting the image into x by m images;
Generating a game matrix of n by m game answers;
Mapping the game answers to the image matrix;

2. The method of claim 1 wherein a physical puzzle is generated

3. The method of claim 1 wherein a digital puzzle is generated.
